(19) United States
(12) Patent Application Publication
(10) Pub. No.: US 2019/0180194 A1
(43) Pub. Date: Jun. 13, 2019

(54) COMPUTER-READABLE RECORDING MEDIUM, ABNORMALITY CANDIDATE EXTRACTION METHOD, AND ABNORMALITY CANDIDATE EXTRACTION APPARATUS

(71) Applicant: FUJITSU LIMITED, Kawasaki-shi (JP)

(72) Inventors: Ken KOBAYASHI, Setagaya (JP); Yuhei Umeda, Kawasaki (JP); Masaru Todoriki, Kita (JP)

(73) Assignee: FUJITSU LIMITED, Kawasaki-shi (JP)

(21) Appl. No.: 16/207,350

(22) Filed: Dec. 3, 2018

(30) Foreign Application Priority Data
Dec. 8, 2017 (JP) 2017-236217

(51) Int. Cl. G06N 20/00

(52) U.S. Cl. CPC G06N 20/00

(57) ABSTRACT

An extraction apparatus generates a plurality of Betti series based on Betti numbers obtained by performing a persistent homology transform on a plurality of pseudo-attractors generated from a plurality of pieces of time-series data. The extraction apparatus generates a plurality of transformed Betti series in which a region with a larger radius at the time of generating the Betti numbers is weighted more than a region with a smaller radius from the plurality of Betti series. The extraction apparatus extracts abnormality candidates from the plurality of pieces of time-series data based on the Betti number in the plurality of transformed Betti series.

### CROSS-REFERENCE TO RELATED APPLICATION

This application is based upon and claims the benefit of priority of the prior Japanese Patent Application No. 2017-236217, filed on Dec. 8, 2017, the entire contents of which are incorporated herein by reference.

### FIELD

The embodiments discussed herein are related to an abnormality candidate extraction program, an abnormality candidate extraction method, and an abnormality candidate extraction apparatus.

### BACKGROUND

As a technique for analyzing time-series data to detect a change corresponding to an abnormality of data, there is known a method of executing a persistent homology transform on a pseudo-attractor, which is a finite number of attractors generated from the time-series data, to calculate Betti numbers and analyzing the data by a Betti series using the Betti numbers.
[Patent Literature 1] Japanese Laid-open Patent Publication No. 2017-97643
[Patent Literature 2] Japanese Laid-open Patent Publication No. 2009-192312
[Patent Literature 3] Japanese Laid-open Patent Publication No. 2004-78981

Meanwhile, as a method of using the above technique, there are a case where an abnormality or the like is detected by supervised learning using known time-series data which has been known to be abnormal and a case where an abnormality or the like is detected by unsupervised learning based on a change of a Betti series itself. In the above technique, however, when the abnormality or the like is detected by the unsupervised learning using the Betti series as an input, it is not always possible to recognize a shape change of a pseudo-attractor to be detected so that there is a case where the accuracy of abnormality detection may deteriorate regarding the unsupervised time-series data analysis.

Specifically, structural features of the time-series data are characterized by the shape of the pseudo-attractor, and an important change in the time-series data appears as a change in the Betti number of a region with a large radius in the Betti series. FIG. 13 is a diagram for describing properties of the pseudo-attractor. As illustrated in FIG. 13, when the pseudo-attractor changes from (a) of FIG. 13 to (b) of FIG. 13, the shape of the pseudo-attractor as a whole changes. On the other hand, even if a diameter L changes into two values from the state of (b) of FIG. 13, a change in the shape of the pseudo-attractor as a whole is small. That is, the change of the Betti number is regarded to have a higher degree of importance as a quantity representing the change in the shape of the pseudo-attractor as the radius increases, and as the number of holes in the pseudo-attractor represents a global shape of the pseudo-attractor as the radius increases.

However, a Betti number in a region with the large radius is determined to be a part of the entire Betti series since the Betti number is calculated with an upper limit of the radius in the Betti series obtained using the above technique. Thus, the amount of information occupied by the Betti numbers in the region with the large radius in the Betti series is relatively small as compared to a region with a small radius. For example, in a case where the Betti number has changed from 60 to 59 in the region with the small radius, and a case where the Betti number has changed from 2 to 1 in the region with the large radius, the amount of change is regarded to be the same regardless of the global shape of the pseudo-attractor although the change in the Betti number of the region with the large radius is small.

Even in such a case, it is possible to ignore a change that is irrelative to a teacher label since a change with respect to the teacher label is learned in the supervised learning, and thus, it is possible to detect an abnormality in analysis of time-series data. On the other hand, a change of the entire Betti series as a feature amount is observed in the unsupervised learning, and thus, a feature amount that causes the amount of information to be relatively large in a change of a portion of interest as compared with a change of a portion of non-interest is preferably used as an input. However, the amount of change is regarded to be the same as described above so that it is difficult to properly detect a change in the Betti number in a region with a large radius and it is difficult to detect an abnormality in analysis of time-series data.

In this manner, the amount of change in the region with the large radius, which is preferably detected, is not as large as the amount of change in the region with the small radius in the time-series data. Thus, when the abnormality or the like is detected from the Betti series by the unsupervised learning using the same method as the supervised learning, there arises a problem that it is not always possible to recognize the change corresponding to the abnormality to be detected.

### SUMMARY

According to an aspect of an embodiment, a non-transitory computer-readable recording medium stores therein an abnormality candidate extraction program that causes a computer to execute a process. The process includes first generating a plurality of Betti series based on Betti numbers obtained by applying persistent homology transform to a plurality of pseudo-attractors generated, respectively, from a plurality of pieces of time-series data; second generating a plurality of transformed Betti series in which a region with a larger radius when generating the Betti numbers is weighted more than a region with a smaller radius, from the plurality of Betti series; and third extracting an abnormality candidate from the plurality of pieces of time-series data based on the Betti numbers in the plurality of transformed Betti series.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for describing an entire example of an extraction apparatus according to a first embodiment;

FIG. 2 is a functional block diagram illustrating a functional configuration of the extraction apparatus according to the first embodiment;

FIG. 3 is a graph illustrating an example of time-series data;

FIG. 4 is a view illustrating an example of time-series data to be learned;

FIGS. 5A to 5D are views for describing a persistent homology;

FIG. 6 is a view for describing a relationship between barcode data and consecutive data to be generated;

FIG. 7 is a graph for describing an example of monotonically decreasing an interval of a radius for calculating a Betti number;

FIG. 8 is a view for describing a modified Betti series using thinning-out;

FIG. 9 is a flowchart illustrating flow of processing;

FIG. 10 is a graph for describing an example of the modified Betti series;

FIG. 11 is a graph for describing change point detection by the modified Betti series;

FIG. 12 is a diagram for describing a hardware configuration example; and

FIG. 13 is a diagram for describing properties of a pseudo-attractor.

### DESCRIPTION OF EMBODIMENTS

Preferred embodiments will be explained with reference to accompanying drawings. Incidentally, the invention is not limited by the embodiments. In addition, the respective embodiments can be appropriately combined within a range without contradiction.

### [a] First Embodiment

Overall Configuration

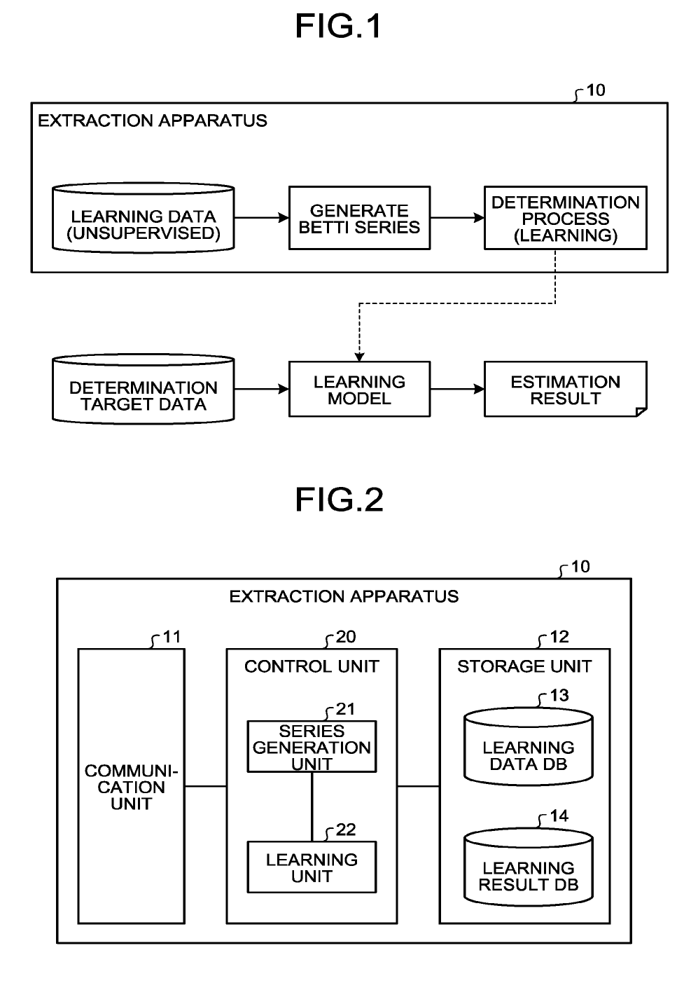

FIG. 1 is a diagram for describing an entire example of an extraction apparatus according to a first embodiment. As illustrated in FIG. 1, an extraction apparatus 10 according to the first embodiment executes a persistent homology transform on learning data, which is unsupervised time-series data, to generate a Betti series. Then, the extraction apparatus 10 executes a determination process (learning process) using machine learning and deep learning (DL) or the like with the Betti series as a feature amount, and learns a neural network (NN) or the like so as to be capable of correctly discriminating (classifying) learning data for each event.

For example, the extraction apparatus 10 generates the Betti series from each of a plurality of pieces of time-series data and extracts time-series data of which event has been changed from another time-series data based on the Betti series. Then, the extraction apparatus 10 performs learning so as to be capable of discriminating an event corresponding to normal time-series data from an event corresponding to time-series data in which the change is detected. Thereafter, a learning model to which a learning result has been applied is used to estimate an accurate event (label) of discrimination target data.

Specifically, the extraction apparatus 10 generates a plurality of Betti series based on Betti numbers obtained by performing a persistent homology transform on a plurality of pseudo-attractors generated from the plurality of pieces of time-series data. The extraction apparatus 10 generates a plurality of transformed Betti series (modified Betti series) in which a region with a larger radius at the time of generating the Betti numbers is weighted more than a region with a smaller radius from the plurality of Betti series. The extraction apparatus 10 extracts abnormality candidates from the plurality of pieces of time-series data based on the Betti number in the plurality of transformed Betti series.

That is, the extraction apparatus 10 constructs the modified Betti series in which properties of the pseudo-attractor, “a change in the number of holes represents a change with a global shape as it is a change of a portion with a larger radius, and an importance degree indicating the change monotonically increases according to the radius” are saved, and this modified Betti series is used as an input of unsupervised learning. As a result, the extraction apparatus 10 can recognize a change corresponding to an abnormally in unsupervised time-series data analysis. Incidentally, the extraction apparatus 10 is an example of computer devices such as a server, a personal computer, and a tablet. In addition, the extraction apparatus 10 and a device that executes the estimation process using the learning model can be realized by separate devices, or can be realized by one device.

Functional Configuration

FIG. 2 is a functional block diagram illustrating a functional configuration of the extraction apparatus 10 according to the first embodiment. As illustrated in FIG. 2, the extraction apparatus 10 includes a communication unit 11, a storage unit 12, and a control unit 20.

The communication unit 11 is a processing unit that controls communication with other devices, and is a communication interface, for example. For example, the communication unit 11 receives a processing start instruction from a terminal of an administrator. In addition, the communication unit 11 receives learning data (input data) from the terminal of the administrator and the like and stores the received data in a learning data DB 13.

The storage unit 12 is an example of storage devices that store programs and data, and is a memory or a hard disk, for example. The storage unit 12 stores the learning data DB 13 and a learning result DB 14.

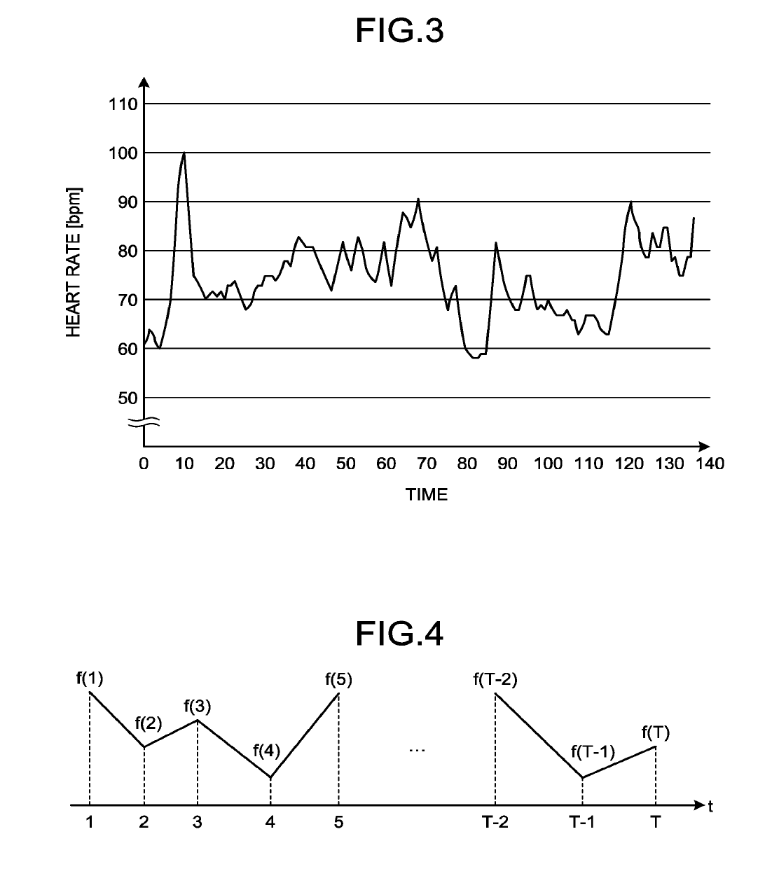

The learning data DB 13 is a database storing data to be learned. Specifically, the learning data DB 13 stores unsupervised time-series data. FIG. 3 is a graph illustrating an example of the time-series data. FIG. 3 is time-series data indicating a change of a heart rate and in which the vertical axis represents the heart rate (beats per minute) and the horizontal axis represents time.

Although the time-series data of the heart rate is exemplified as consecutive data here, the consecutive data is not limited to such time-series data. For example, the consecutive data may be biometric data (time-series data of brain waves, pulses, or body temperature) other than the heart rate, data of a wearable sensor (time-series data of a gyro sensor, an acceleration sensor, or a geomagnetic sensor), financial data (time-series data of an interest rate, a price, balance of international payments, or a stock price), data on natural environment (time-series data of temperature, humidity, or carbon dioxide concentration), social data (data of labor statistics or demographics), or the like. However, it is assumed that the consecutive data as a target of the present embodiment is data that changes conforming to at least a rule of Formula (1).

x(i)=f(x(i−1), . . . , x(i−2),x(i−N)) (1)

The learning result DB 14 is a database storing a learning result. For example, the learning result DB 14 stores a discrimination result (classification result) of the learning data obtained by the control unit 20, and various parameters learned by machine learning and deep learning.

The control unit 20 is a processing unit that controls the entire processing of the extraction apparatus 10, and is a processor or the like, for example. The control unit 20 includes a series generation unit 21 and a learning unit 22. The series generation unit 21 and the learning unit 22 are examples of an electronic circuit included in the processor or the like and a process executed by the processor or the like. In addition, the series generation unit 21 is an example of a first generation unit and a second generation unit, and the learning unit 22 is an example of an extraction unit.

The series generation unit 21 is a processing unit that generates a plurality of Betti series based on the Betti numbers obtained by the persistent homology transform of the plurality of pseudo-attractors generated, respectively, from the plurality of pieces of time-series data stored in the learning data DB 13. In addition, the series generation unit 21 is the processing unit that generates the plurality of modified Betti series in which a region with a larger radius at the time of generating the Betti numbers is weighted more than a region with a smaller radius, from the plurality of Betti series.

Specifically, the series generation unit 21 generates the modified Betti series after or in the middle of creating the Betti series using the same method as in Japanese Laid-open Patent Publication No. 2017-97643. Here, the generation of the Betti series and the generation of the modified Betti series will be specifically described.

Generation of Betti Series

First, the generation of the Betti series using the same method as in Japanese Laid-open Patent Publication No. 2017-97643 will be briefly described with reference to FIGS. 4 to 6. In Japanese Laid-open Patent Publication No. 2017-97643, a section [rₘᵢₙ, rₘₐₓ] of a radius for calculating a Betti number is equally divided by m−1, a Betti number B(rᵢ) in each radius rᵢ (i=1, . . . , m) is calculated, and a Betti series of [B(r₁), B(r₂), B(r₃), . . . , B(rₘ)] in which the Betti numbers are arrayed is generated.

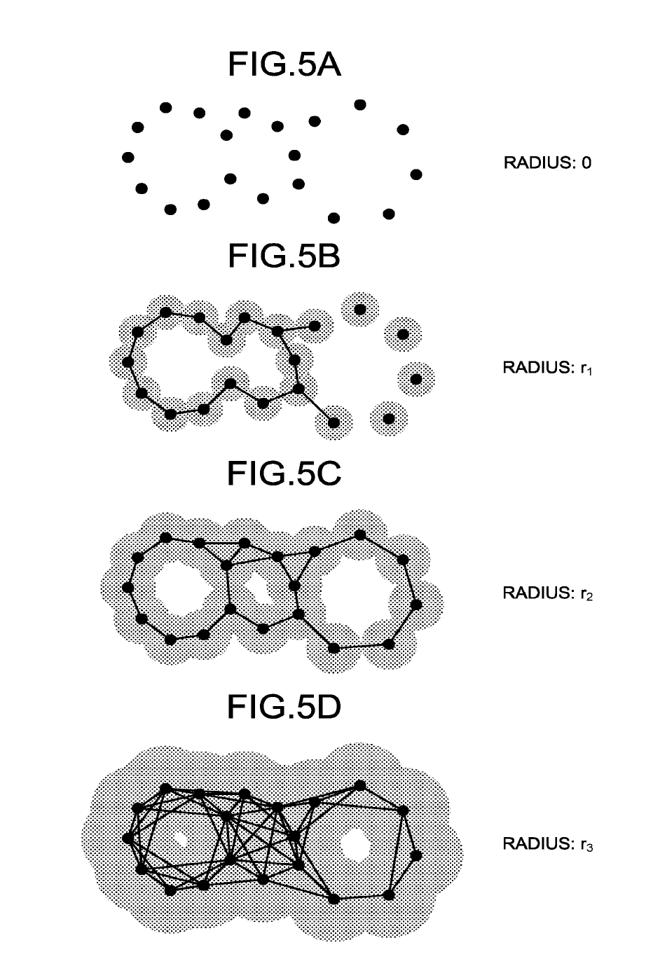

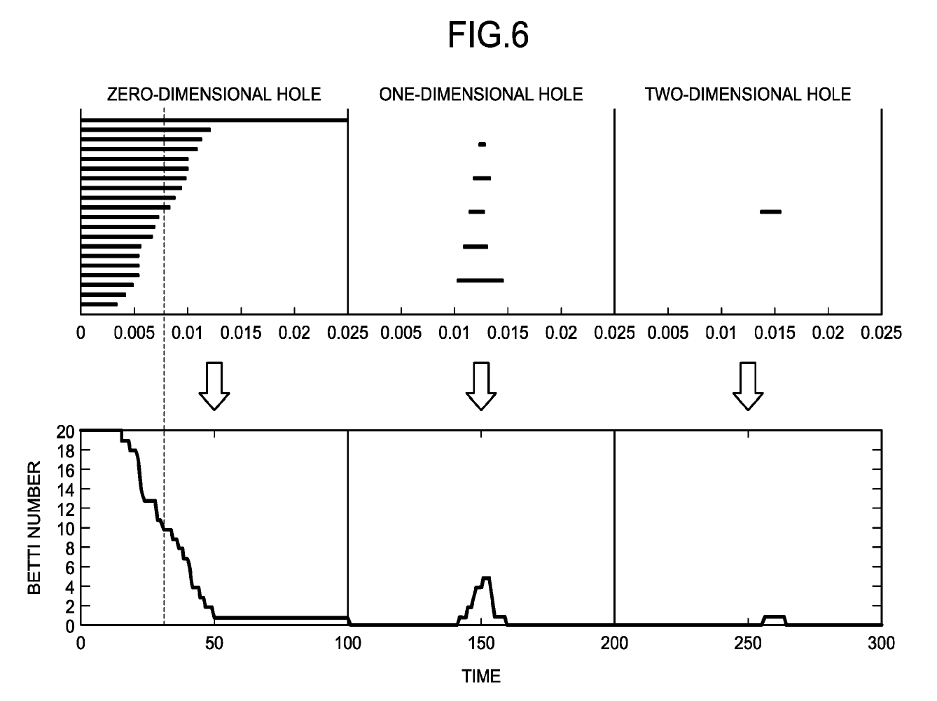

FIG. 4 is a view illustrating an example of the time-series data to be learned. FIGS. 5A to 5D are views for describing a persistent homology. FIG. 6 is a view for describing a relationship between barcode data and generated consecutive data.

The generation of the pseudo-attractor will be described with reference to FIG. 4. For example, consecutive data represented by a function f(t) (t represents time) as illustrated in FIG. 4 is considered. Further, it is assumed that f(l), f(2), f(3), . . . , f(T) are given as actual values. The pseudo-attractor in the present embodiment is a set of points on an N-dimensional space of which components are values of N points taken at every delay time τ (τ≥1) out of the consecutive data. Here, N represents an embedded dimension, and generally, N=3 or 4. For example, when N=3 and τ=1, the following pseudo-attractor including (T−2) points is generated.

Pseudo-attractor={(f(1),f(2),f(3)), (f(2),f(3),f(4)), (f(3),f(4),f(5)), . . . , (f(T−2),f(T−1),f(T))}

Subsequently, the series generation unit 21 generates a pseudo-attractor and transforms the pseudo-attractor into a Betti series using the persistent homology transform. Here, the attractor generated here is a set of a finite number of points, and thus, is referred to as the “pseudo-attractor”.

Here, a “homology” is a method of expressing a feature of a target using the number of m-dimensional holes (m≥0). The “hole” referred to herein is an origin of a homology group, a zero-dimensional hole is a connection component, a one-dimensional hole is a hole (tunnel), and a two-dimensional hole is a cavity. The number of holes in each dimension is referred as the Betti number. Further, the “persistent homology” is a method configured to characterize transition of m-dimensional holes in the target (here, the set of points (point cloud), and it is possible to investigate features related to arrangement of points using the persistent homology. In this method, each point in the target gradually inflates into a spherical shape, and a generation time of each hole (represented by a radius of a sphere at the time of generation) and a disappearance time of each hole (represented by a radius of a sphere at the time of disappearance) are specified in the course of inflation.

The persistent homology will be described in more detail with reference to FIGS. 5A to 5D. As a rule, centers of two spheres are connected by a line segment when one sphere contacts, and centers of three spheres are connected by line segments when three spheres contact each other. Here, only the connected components and holes are considered. In the case (radius r=0) of FIG. 5A, only the connected components are generated and no hole is generated. In the case (radius r=r₁) of FIG. 5B, holes are generated and some of the connected components disappear. In the case (radius r=r₂) of FIG. 5C, more holes are generated, and only one connected component persists. In the case (radius r=r₃) of FIG. 5D, the number of connected components remains one, and one hole disappears.

In the course of calculating the persistent homology, a generation radius and a disappearance radius of a source (that is, the hole) of a homology group are calculated. Barcode data can be generated using the generation radius and the disappearance radius of the hole. Since the barcode data is generated for each hole dimension, one block of barcode data can be generated by integrating barcode data of a plurality of hole dimensions. The consecutive data is data illustrating a relationship between a radius (that is, time) of a sphere in the persistent homology and a Betti number.

A relationship between the barcode data and the generated consecutive data will be described with reference to FIG. 6. The upper graph is a graph generated from the barcode data and in which the horizontal axis represents a radius. The lower graph is a graph generated from the consecutive data (sometimes referred to as the “Betti series”), and in which the vertical axis represents a Betti number and the horizontal axis represents time. As described above, the Betti number represents the number of holes. For example, the number of holes existing at the time of the radius corresponding to the broken line in the upper graph is ten, and thus, the Betti number corresponding to the broken line is also ten in the lower graph. The Betti number is counted for each block. Since the lower graph is a graph of pseudo time-series data, a value on the horizontal axis itself has no meaning.

In the conventional method, a discrimination process is executed using the Betti series generated in this manner as an input. However, the Betti series illustrated in FIG. 6 uniformly handles a change in the number of holes in each radius, and thus, it is difficult to detect a change in a feature amount in learning of the unsupervised time-series data based on the shape change of the pseudo-attractor. Therefore, the modified Betti series in which the properties of the pseudo-attractor, “a change in the number of holes represents a change with a global shape as it is a change of a portion with a larger radius, and an importance degree indicating the change monotonically increases according to the radius” are saved is constructed in the present embodiment.

Specifically, the series generation unit 21 generates the modified Betti series using “Method 1: To monotonically decrease an interval of a radius for calculating a Betti number in calculation of a Betti number” or “Method 2: To calculate a weighted Betti number by applying a monotonically increasing weight with respect to a radius”. Next, Method 1 and Method 2 will be specifically described.

Method 1: Modified Betti Series

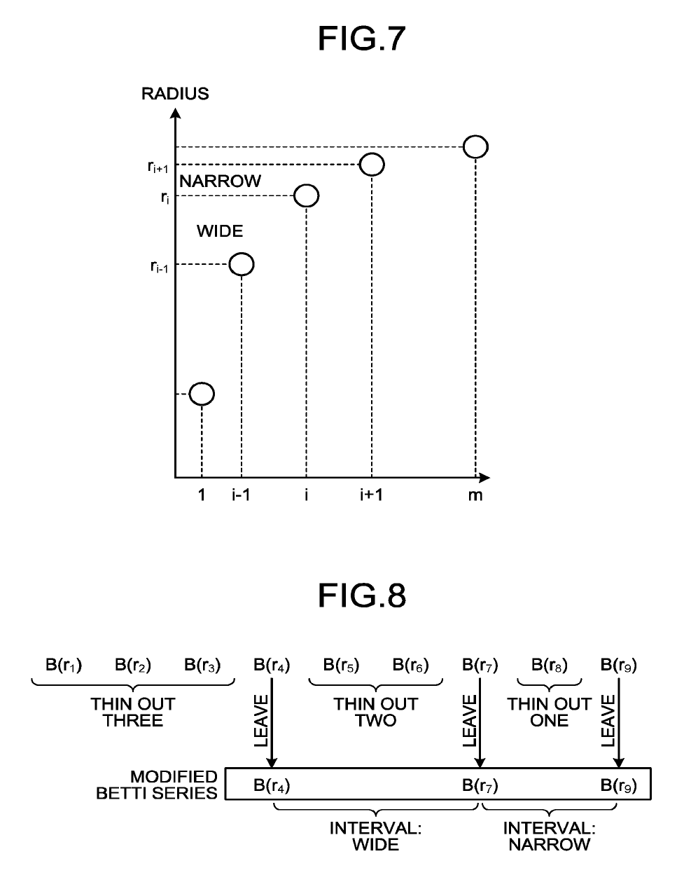

Method 1 is a method of saving properties of a pseudo-attractor by constructing a Betti series in which a change in a Betti number is represented in more detail as a size of a radius increases. FIG. 7 is a graph for describing an example of monotonically decreasing an interval of a radius for calculating a Betti number. As illustrated in FIG. 7, in Method 1, a change in a portion with a large radius is regarded as important by monotonically decreasing the interval of radius rᵢ along with an increase of i of the radius rⱼ.

For example, the series generation unit 21 sets a radius for calculating an i-th Betti number in the section [rₘᵢₙ, rₘₐₓ] of the radius for calculating the Betti number as Formula (2). Here, R(i) satisfies R(1)=rₘᵢₙ, and R(m)=rₘₐₓ. Further, the series generation unit 21 calculates a Betti number B(rᵢ) in each radius rᵢ. Thereafter, the series generation unit 21 sets [B(r₁), B(r₂), B(r₃), . . . , B(rₘ)] obtained by arraying the respective Betti numbers as the modified Betti series.

$${r}_{i} = R ( i ) = - \frac{{r}_{max} - {r}_{min}}{{( 1 - m )}^{2}} {( i - m )}^{2} + {r}_{max} \qquad ( 2 )$$

Incidentally, it suffices if the i-th radius R(i) is a function that satisfies Formula (3), in other words, a function with a monotonically decreasing inclination, and, for example, it is possible to use a quadratic function as illustrated in Formula (4) or an exponential function as illustrated in Formula (5). In Formula (5), a>0, b is determined so as to satisfy R(1)=rₘᵢₙ and R(m)=rₘₐₓ.

$$\begin{matrix}R ( 1 ) = {r}_{min} , R ( m ) = {r}_{max} and R ( i ) - R ( i - 1 ) \geq R ( i + 1 ) - R ( i ) ( i = 2 , ⋯ , m - 1 ) & ( 3 ) \\ R ( i ) = - \frac{{r}_{max} - {r}_{min}}{{( 1 - m )}^{2}} {( i - m )}^{2} + {r}_{max} & ( 4 ) \\ R ( i ) = - a exp ( - i ) + b & ( 5 )\end{matrix}$$

Next, another example using Method 1 will be described. Specifically, the series generation unit 21 equally divides the section [rₘᵢₙ, rₘₐₓ] of the radius for calculating the Betti number by m−1, and calculates the Betti number B(rᵢ) in each radius rᵢ (i=1, . . . , m). Subsequently, the series generation unit 21 thins out the Betti numbers while decreasing the interval one by one in such a manner that p Betti numbers are thinned out to leave one Betti number and (p−1) Betti numbers are thinned out to leave one Betti number sequentially from the first Betti number out of the Betti series [B(r₁), B(r₂), B(r₃), . . . , B(rₘ)] in which the Betti numbers are arrayed. Thereafter, the series generation unit 21 sets a series of Betti numbers remaining after the thinning-out as a modified Betti series.

FIG. 8 is a view for describing the modified Betti series using the thinning-out. FIG. 8 illustrates the case of m=9, which is an example in which [B(r₁), B(r₂), B(r₃), B(r₄), B(r₅), B(r₆), B(r₇), B(r₈), B(r₉)] is calculated as the Betti series. In this case, the series generation unit 21 thins out the first three Betti numbers to leave B(r₄), thins out the next two Betti numbers to leave B(r₇), and thins out the next one Betti number to leave B(r₉). In this manner, the series generation unit 21 generates a modified Betti series [B(r₄), B(r₇), B(r₉)]. Incidentally, a method of thinning out the Betti series is not limited to the above method, and any thinning method may be used as long as a thinning interval monotonically decreases. Incidentally, a timing for thinning-out may be a timing of generating the Betti series or a timing of generating the modified Betti series after generation of the Betti series, and the setting can be arbitrarily changed.

Method 2: Modified Betti Series

For example, the series generation unit 21 calculates Betti numbers B(rᵢ) in each radius rᵢ (i=1, . . . , m). Here, it is assumed that a section of a radius for calculating a Betti number is [rₘᵢₙ, rₘₐₓ], and rₘᵢₙ=r₁<r₂<rₘ=rₘₐₓ.

Subsequently, the series generation unit 21 multiplies the Betti number B(rᵢ) calculated for each radius by W(rᵢ)=exp(rᵢ) as a weight, and calculates the weighted Betti number as in Formula (6). Then, the series generation unit 21 sets the expression (7), which is a series in which the weighted Betti number is arranged, as a modified Betti series.

\hat{B}(rᵢ)=W(rᵢ)×B(rᵢ) (6)

series[\hat{B}(r₁),\hat{B}(r₂), . . . , \hat{B}(rₘ)] (7)

Incidentally, it suffices that the weight W(r) may be a function that monotonically increases with respect to the radius r, such as W(r₁)≤W(r₂) when 0≤rᵢ≤r₂. For example, it is possible to use a linear function such as W(r)=r, a monotonically-increasing high-order function such as mW(r)=r^{p} (p>1), and an exponential function such as W(r)=exp(r).

Returning to FIG. 2, the learning unit 22 is a processing unit that executes a learning process using the modified Betti series generated by the series generation unit 21 as an input. Specifically, the learning unit 22 extracts an abnormality candidate from the plurality of pieces of time-series data based on the Betti numbers in the plurality of modified Betti series. For example, the learning unit 22 performs learning such that an event of the time-series data can be discriminated by extracting the abnormality candidate of the time-series data based on the Betti numbers of the modified Betti series. That is, the learning unit 22 classifies time-series data as an event A and time-series data as an event B, and detects a generation point of an event different from other events out of the time-series data.

Then, the learning unit 22 performs learning by deep learning (DL) or the like such that the event can be classified from the feature amount of the time-series data, and stores a learning result in the learning result DB 14. The learning result includes a classification result of the point process time-series data (that is, an output of the learning by DL), and various parameters of a neural network at the time of calculating the output from the input may be included.

Flow of Processing

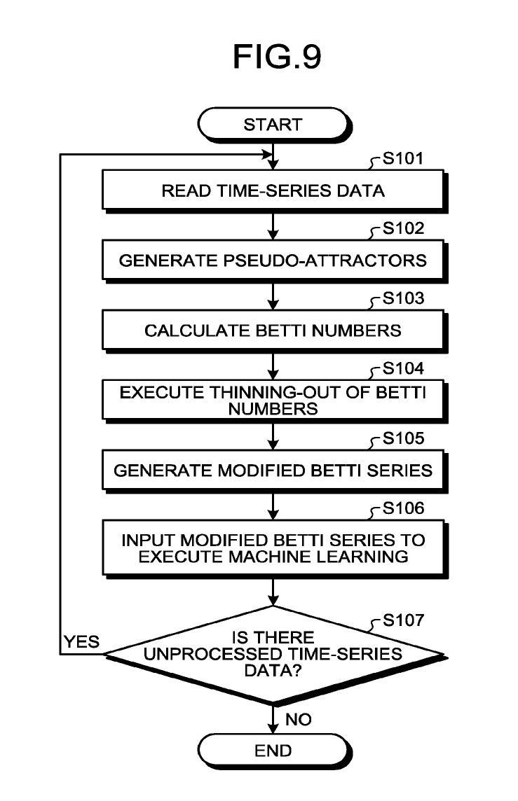

Next, the above-described processing will be described. Here, generation processing of the modified Betti series by thinning-out will be described as an example. FIG. 9 is a flowchart illustrating flow of the processing.

As illustrated in FIG. 9, the series generation unit 21 reads time-series data from the learning data DB 13 (S101), and generates a pseudo-attractor (S102). Subsequently, the series generation unit 21 calculates Betti numbers from the pseudo-attractor (S103), performs thinning out of the Betti numbers (S104), and generates a modified Betti series (S105).

Then, the learning unit 22 executes machine learning with the modified Betti series as an input (S106). Thereafter, the processes of S101 and the subsequent steps are repeated if there is unprocessed time-series data (S107: Yes), and the processing is ended if there is no unprocessed time-series data (S107: No).

Effect

As described above, the extraction apparatus 10 can generate the modified Betti series obtained by leaving properties that the larger radius has the more importance as the amount representing the change when the topological data analysis is applied to the time-series data to perform the unsupervised learning to detect the change of the shape of the pseudo-attractor. Thus, the extraction apparatus 10 can perform the unsupervised learning of the time-series data based on the shape change of the pseudo-attractor, and can perform the unsupervised learning based on a structural change of the time-series data.

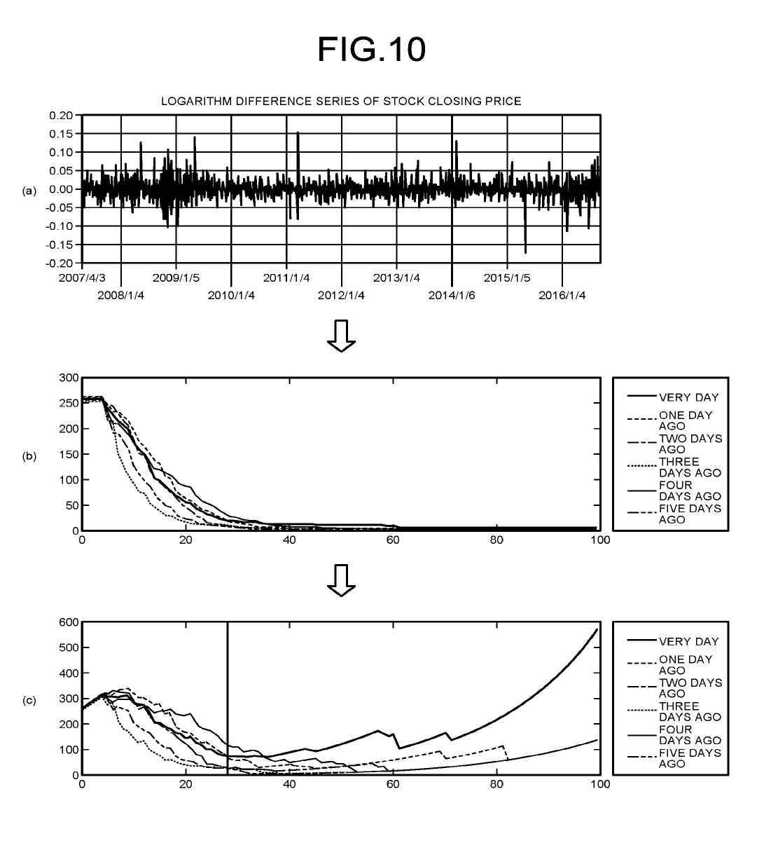

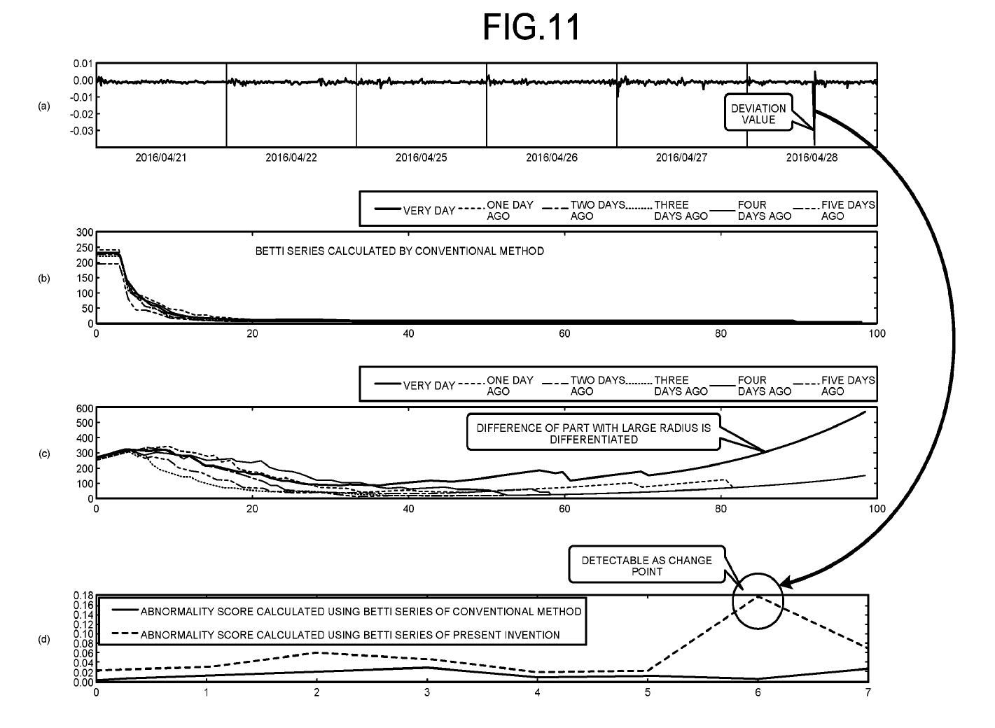

This will be specifically described with reference to FIGS. 10 to 11. FIG. 10 is a graph for describing an example of the modified Betti series. FIG. 11 is a graph for describing change point detection by the modified Betti series. (a) of FIG. 10 illustrates a logarithm difference series of a stock closing price. Although an event indicating a large change occurs on each day, the logarithm difference series of the stock closing price is unsupervised data, and thus, a difference in a Betti series between the respective days is small as illustrated in (b) of FIG. 10 when the conventional method is used to generate the Betti series. Therefore, it is difficult to detect whether the event has occurred or not even if learning is performed as it is.

On the other hand, the extraction apparatus 10 can generate a modified Betti series illustrated in (b) of FIG. 10 from the conventional Betti series illustrated in (c) of FIG. 10 by calculating a weighted Betti number obtained by multiplying a Betti number of each radius by a weight monotonically increasing according to a size of the radius. Therefore, it is possible to execute unsupervised learning using the modified Betti series in which the magnitude of an event of each day appears as an input, and thus, it is possible to recognize a change corresponding to an abnormally in unsupervised time-series data analysis.

In addition, (a) of FIG. 11 is time-series data illustrating fluctuations of the stock price. There is a case where such time-series data instantaneously takes a different value (deviation value) in scale and the like. In this case, the difference is hardly differentiated even by calculating the Betti number from the stock price time-series data as illustrated in (b) of FIG. 11. However, a difference in a portion with a large radius is differentiated by multiplying the Betti number by a weight exponentially increasing with respect to the size of the radius as illustrated in (c) of FIG. 11. As a change point is detected based on the weighted modified Betti series, a deviation value from source time-series data can be detected as the change point as illustrated in (d) of FIG. 11.

### [b] Second Embodiment

Although the embodiment of the invention has been described so far, the invention may be implemented in various different modes in addition to the embodiment described above.

Learning Method

The learning of the first embodiment is not limited to the deep learning (DL), but another machine learning can be adopted. In addition, the number of dimensions of an interval attractor can be arbitrarily set. When label estimation of data to be estimated is performed after learning, the same processing as that at the time of learning is performed and input to a learning model.

Hardware

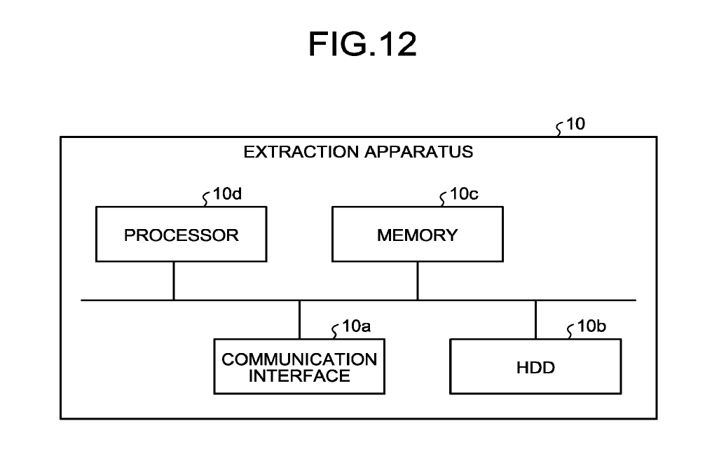

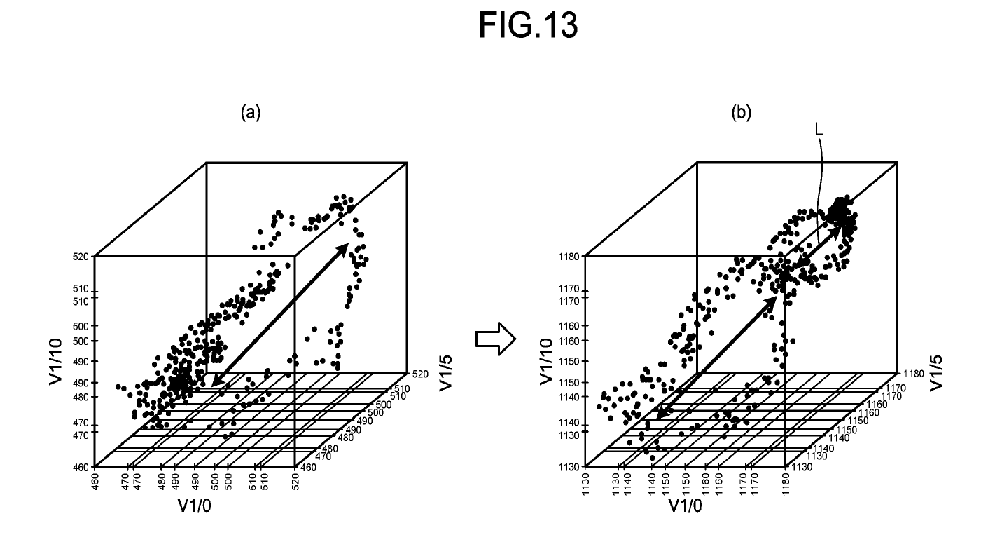

FIG. 12 is a diagram for describing a hardware configuration example. As illustrated in FIG. 12, the extraction apparatus 10 includes a communication interface 10a, a hard disk drive (HDD) 10b, a memory 10c, and a processor 10d. In addition, the respective units illustrated in FIG. 12 are mutually connected by a bus or the like.

The communication interface 10a is a network interface card or the like and communicates with other servers. The HDD 10b stores a program and a DB for operating the functions illustrated in FIG. 2.

The processor 10d reads a program for executing the same processing as each processing unit illustrated in FIG. 2 from the HDD 10b or the like and develops the read program in the memory 10c, thereby operating the process of executing each function described in FIG. 2 and the like. That is, this process executes the same function as each processing unit of the extraction apparatus 10. More specifically, the processor 10d reads the programs having the same functions as the series generation unit 21, the learning unit 22, and the like from the HDD 10b or the like. Then, the processor 10d executes the process of executing the same processing as the series generation unit 21, the learning unit 22, or the like.

In this manner, the extraction apparatus 10 operates as an information processing device that executes the extraction method by reading and executing the program. In addition, the extraction apparatus 10 can also realize the same functions as the above-described embodiment by reading the above-described program from a recording medium by a medium reading device and executing the read program. Incidentally, the program according to this other embodiment is not limited to being executed by the extraction apparatus 10. For example, the invention can be similarly applied when another computer or server executes the program, or when these computer and server execute the program in collaboration.

System

Information including processing procedures, control procedures, specific terms, various data and parameters illustrated in the above document and drawings can be arbitrarily changed except the case of being particularly noted.

In addition, each component of each device illustrated in the drawings is a functional idea and thus is not always be configured physically as illustrated in the drawings. That is, specific modes of distribution and integration of each device are not limited to those illustrated in the drawings. That is, all or a part thereof may be configured to be functionally or physically separated or integrated in arbitrary units depending on various loads, use situations, and the like. For example, it is also possible to realize a processing unit that displays items and a processing unit that estimates a preference with different housings. Further, for each processing function to be performed by each device, all or any part of the processing functions may be implemented by a CPU and a program analyzed and executed by the CPU or may be implemented as hardware by wired logic.

According to the embodiments, it is possible to recognize a change corresponding to an abnormality in unsupervised time-series data analysis.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium having stored therein an abnormality candidate extraction program that causes a computer to execute a process comprising:
first generating a plurality of Betti series based on Betti numbers obtained by applying persistent homology transform to a plurality of pseudo-attractors generated, respectively, from a plurality of pieces of time-series data;
second generating a plurality of transformed Betti series in which a region with a larger radius when generating the Betti numbers is weighted more than a region with a smaller radius, from the plurality of Betti series; and
third extracting an abnormality candidate from the plurality of pieces of time-series data based on the Betti numbers in the plurality of transformed Betti series.

2. The non-transitory computer-readable recording medium according to claim 1, wherein,
the second generating includes determining an interval of a radius for calculating the Betti numbers using a function of monotonically decreasing the interval, calculating the Betti numbers with the determined interval, and generating the plurality of transformed Betti series using the respective calculated Betti numbers.

3. The non-transitory computer-readable recording medium according to claim 1, wherein,
the second generating includes acquiring Betti numbers at intervals monotonically decreasing as a radius increases from Betti numbers of each radius included in the plurality of Betti series, and generating the plurality of transformed Betti series using the acquired Betti numbers of the respective radii.

4. The non-transitory computer-readable recording medium according to claim 1, wherein,
the second generating includes calculating a plurality of weighted Betti numbers obtained by multiplying a Betti number of each radius included in the plurality of Betti series by a weight monotonically increasing with respect to the radius, and generating the plurality of transformed Betti series using the calculated plurality of weighted Betti number.

5. An abnormality candidate extraction method comprising:
generating a plurality of Betti series based on Betti numbers obtained by applying persistent homology transform to a plurality of pseudo-attractors generated, respectively, from a plurality of pieces of time-series data, using a processor;
generating a plurality of transformed Betti series in which a region with a larger radius when generating the Betti numbers is weighted more than a region with a smaller radius, from the plurality of Betti series, using the processor; and
extracting an abnormality candidate from the plurality of pieces of time-series data based on the Betti numbers in the plurality of transformed Betti series, using the processor.

6. An abnormality candidate extraction apparatus comprising:
a processor configured to:
generate a plurality of Betti series based on Betti numbers obtained by applying persistent homology transform to a plurality of pseudo-attractors generated, respectively, from a plurality of pieces of time-series data;
generate a plurality of transformed Betti series in which a region with a larger radius when generating the Betti numbers is weighted more than a region with a smaller radius, from the plurality of Betti series; and
extract an abnormality candidate from the plurality of pieces of time-series data based on the Betti numbers in the plurality of transformed Betti series.
